(19) United States
(12) Patent Application Publication
(10) Pub. No.: US 2025/0261573 A1
(43) Pub. Date: Aug. 21, 2025

(54) MANUALLY OPERATED SHOVEL PUSHED BY USER

(71) Applicant: Mattews, LLC, Green Bay, WI (US)

(72) Inventor: Thomas E. Matuszak, Green Bay, WI (US)

(73) Assignee: Mattews, LLC, Green Bay, WI (US)

(21) Appl. No.: 18/443,605

(22) Filed: Feb. 16, 2024

(51) Int. Cl. A01B 1/02

(52) U.S. Cl. CPC A01B 1/022

(57) ABSTRACT

A manually operated shovel designed to be pushed by a user to clear material from a surface, and related method. The shovel includes a blade with length and width, bottom edge, top edge, front face and back face. An elongated-shaft having an elongated-shaft blade end and an elongate-shaft user end. A selectively-pivotable joint is connected with an elongated-shaft blade end and the back face of the blade. The selectively-pivotable joint (i) is fixed in place and (ii) pivots around a joint center point to move an elongated-shaft user end in an arc relative to spaced apart side edges of the blade. A T-shaped handle is connected with the elongated-shaft user end and the T-shaped handle is selectively-adjustable to enable the user to adjust a position of the T-shaped handle relative to the elongated-shaft user end.

### TECHNICAL FIELD

This invention generally relates to shovels. More specifically, this relates to a manually operated shovel pushed by a user to clear material from a surface, for example, snow or another substance, where push-clearing with a blade at an angle is preferred to shoveling and lifting the material to move it from one place to another.

### BACKGROUND

There exist a variety of shovels, and particularly snow shovels, that attempt to make shoveling material like snow easier and/or quicker. However, as best the inventor can determine, no existing products or methods provide such a quality and efficient means for using a shovel in such an ergonomic and powerful way as the present disclosure. This is particularly necessary when desiring to clear a smaller amount of material from a surface in a snowplow-like manner to successively push material out the side of a shovel forming a row and then come back pushing the row further aside, and eventually to a delivery area, by continuing the snowplow-like action in the same or opposite directions.

### SUMMARY

Without being limited to a theory of understanding, the inventor has surprisingly discovered that providing the desired leverage to push a shovel, and particularly with a blade in a snowplow like manner, is substantially compromised by existing handle configurations, and is further limited by a user's height and pushing preferences (e.g., left hand or right hand dominate). Thus, to meet all needs in a one-size-fits-all shovel (which needs tend to move in opposite directions to each other) and still enable an efficient, effective and ergonomic-friendly push shovel structure and method, the inventor employs key features embodied in a shovel blade, a selectively-pivotable joint, an elongated-shaft with selectively-adjustable T-shaped handle, and the way these features work together.

More particularly, to address one or more deficiencies in the art and better achieve the desirable requirements for a push shovel, particularly when used to push and move or remove material from a surface in a snowplow-like manner, there is provided a manually operated shovel designed to be pushed by a user to clear material from a surface. The shovel includes a blade. The blade includes a length and a width, where the length is greater than the width. The blade also includes a bottom edge to engage the surface and a top edge spaced from the bottom edge. The blade further includes a front face defined between the top edge and the bottom edge. And, the blade includes a back face defined between the top edge and the bottom edge wherein the back face is opposed to and separated from the front face. The shovel further includes an elongated-shaft having an elongated-shaft blade end and an elongate-shaft user end, where the elongated-shaft user end is spaced apart from the elongated-shaft blade end. Further, the shovel includes a selectively-pivotable joint connected with an elongated-shaft blade end and the back face of the blade. The selectively-pivotable joint (i) is fixed in place relative to the length direction of the blade and (ii) pivots around a joint center point to move an elongated-shaft user end in an arc relative to spaced apart side edges of the blade. Yet further, the shovel includes a T-shaped handle connected with the elongated-shaft user end. The T-shaped handle is selectively-adjustable to enable the user to adjust a position of the T-shaped handle relative to the elongated-shaft user end.

In another aspect, there is provided a method for pushing a shovel to clear material from a surface. The method includes using a blade as described herein. The method also includes selectively-pivoting a joint connected with an elongated-shaft blade end and the back face of the blade, where the joint (i) is fixed in place relative to the length direction of the blade and (ii) pivots around a joint center point to move an elongated-shaft user end in an arc relative to spaced apart side edges of the blade. Another step of the method is angularly adjusting a T-shaped handle connected with the elongated-shaft user end to position the T-shaped handle substantially parallel to the surface when the elongated-shaft user end is positioned from ten degrees to forty-five degrees on either side of a perpendicular position defined by the elongated-shaft relative to the blade. Then, this is a step of pushing the shovel to clear material from the surface.

Other aspects of the disclosure are directed to configurations and features for the blade, the selectively-pivotable joint, the T-shaped handle, and combinations thereof.

As used herein, “substantially” means exactly the stated condition and also including plus and minus up to 20 percent of the exact condition. More preferably, and in degrees of increasing preferences, “substantially” means: plus and minus up to 15percent of the exact condition, plus and minus up to 10 percent of the exact condition, plus and minus up to 5 percent of the exact condition, plus and minus up to 2 percent of the exact condition, and the exact condition.

### DESCRIPTION OF THE DRAWINGS

The invention may be more completely understood in consideration of the following detailed description of various features of the invention in connection with the accompanying drawings, in which:

FIG. 1 shows a top front elevation view of a manually operated shovel of this disclosure;

FIG. 2 shows a top view of that seen in FIG. 1, with the shovel laying flat on a surface like a driveway, sidewalk, garage, or other substantially flat surface, and with the elongated-shaft positioned in an angle of 90 degrees, i.e., perpendicular position, relative to the top edge of the blade;

FIG. 3 shows an enlarged view of a portion of the shovel seen in FIGS. 1 and 2, and with the elongated-shaft positioned in an angle less than 90 degrees, i.e., in the range of ten degrees to forty-five degrees, relative to the top edge of the blade, which is in comparison to the 90 degree angle seen in FIGS. 2 and 4;

FIG. 4 shows a front face left elevational view of that seen in FIG. 2;

FIG. 5 shows a back face left elevational view of that seen in FIG. 2;

FIG. 6 shows a right side elevation view of that seen in FIGS. 4 and 5;

FIG. 7 shows a perspective view of the handle and a portion of the elongated-shaft seen in FIG. 1;

FIG. 8 shows a perspective view of that seen in FIG. 8, but in a different position for the handle relative to the elongated-shaft;

FIG. 9 shows an enlarged perspective view of the selectively-pivotable joint in an unlocked configuration;

FIG. 10 shows an enlarged perspective view of the selectively-pivotable joint in a locked configuration;

FIGS. 11A, 11B and 11C are, respectively, a schematic top view and then two schematic back views, of the relative orientation of the blade, the elongated-shaft and the T-shaped handle as further described herein;

FIGS. 12A, 12B and 12C are, respectively, a schematic top view and then two schematic back views, of the relative orientation of the blade, the elongated-shaft and the T-shaped handle as further described herein;

FIGS. 13A, 13B and 13C are, respectively, a schematic top view and then two schematic back views, of the relative orientation of the blade, the elongated-shaft and the T-shaped handle as further described herein;

FIG. 14 is a schematic top view of a shovel as disclosed herein being pushed in a first direction to clear material aside in a material clearing direction in a snowplow-like manner; and,

FIG. 15 is a schematic top view of the shovel depicted in FIG. 14, now being pushed in an opposite direction to clear material aside in the material clearing direction in a snowplow-like manner.

The drawings show some but not all embodiments. The elements depicted in the drawings are illustrative and not necessarily to scale, and the same (or similar) reference numbers denote the same (or similar) features throughout the drawings, though all the same (or similar) features are not always separately numbered to help avoid over numbering and obscuring what the drawings are disclosing.

### DETAILED DESCRIPTION

In accordance with the practice of my innovative shovel, as seen in the Figures for example, now described is my manually operated shovel 10 designed to be pushed by a user 12 to clear material 14 from a surface 16. The shovel 10 includes a blade 20. Blade 20 has a length 22 extending in a length direction 23, and a width 24 extending in the width direction 26. The length 22 is greater than the width 24. Length and width are measured and defined by a straight line from the outer most edge of one side to the outer most edge of the spaced apart, opposite side. And, preferably, in the case of a curved face like that seen in the figures, the curve is ignored and straight line distance from top edge to bottom edge is determined. The blade further includes a bottom edge 31 to engage the surface 16 and a top edge 32 spaced from the bottom edge 31. A front face 36 is defined between the top edge 32 and the bottom edge 31. A back face 40 is defined between the top edge 32 and the bottom edge 31, and the back face is opposed to and separated from the front face by a thickness 21 of the blade. While the faces 36, 40 can take on a variety of shapes, preferably they are, respectively, the front face 36 being concave shaped 38 and the back face 40 being convex shaped 42. More or less curvature can be used as desired by the user to collect and/or throw and roll the material forward ahead of and out of the shovel as the shovel is being used to clear material from the surface.

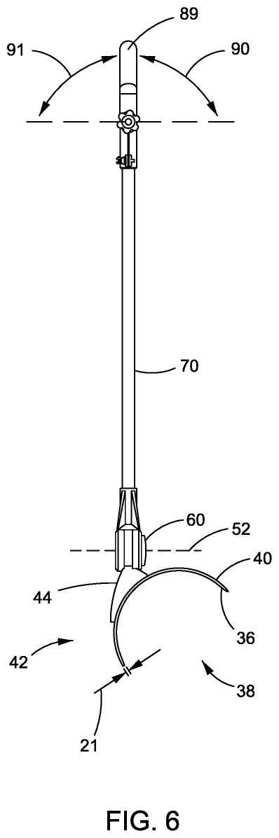

Shovel 10 further includes an elongated-shaft 70. Shaft 70 has an elongated-shaft blade end 72 and an elongated-shaft user end 74. The user end 74 is spaced apart from the blade end 72, and each is located on opposite ends of the shaft 70. A selectively-pivotable joint 50 is connected with the elongated-shaft blade end 72 and the back face 40 of the blade. For example, the joint 50 can connect with back face 40 directly (not shown) or more indirectly as shown via extension 44. Extension 44 helps provide more versatility and/or leverage for connecting joint 50 and face 40. Extension 44 can be molded right into and as part of blade 20, or it can be separately formed and then connected to blade 20 at face 40. Additionally, preferably, if desired, the elongated-shaft 70 can have a shaft length direction 76 that is parallel with at least a portion of the blade in width direction 26 of the blade (e.g., best seen in FIG. 6). This can be advantageous, for additional reasons discussed herein regarding joint 50. The selectively-pivotable joint 50 is fixed in place relative to the length direction of the blade, and preferably, fixed in the width direction as well. Joint 50 functions to pivot around a joint center point 52 to move the elongated-shaft 70, and most pronouncedly move the shaft user end 74 in an arc 54 relative to spaced apart side edges 34 of the blade 20.

A T-shaped handle 80 is connected with the elongated-shaft user end 74. The T-shaped handle 80 is selectively-adjustable to enable the user to adjust a position 82 of the T-shaped handle 80 relative to the elongated-shaft user end 74. As used herein, T-shaped can be exactly a T at the user end 74 as seen in the drawings, and also includes any extension off of the user end 74 that radiates outwardly from the user end at least one inch, preferably at least 2 inches, more preferably at least 3 inches, and even more preferably at least 4 inches, to form a structure the user can hold onto more easily and that helps push forward the shovel 10. Further in this regard, the structure radiating off of end 74 does so at an angle of preferably at least 10 degrees, more preferably at least 20 degrees, even more preferably at least 30 degrees, yet more preferably at least 40 degrees and most preferably 70 to 100 degrees relative to the shaft length direction 76. Preferably, such radiating off structure does so on both sides of the user end 74, as seen, and does so evenly on each side, all for providing even better leverage to the user pushing the shovel.

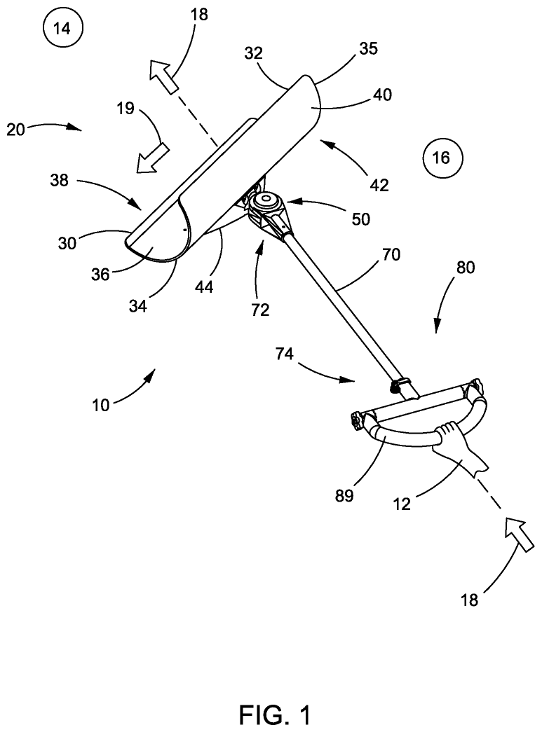

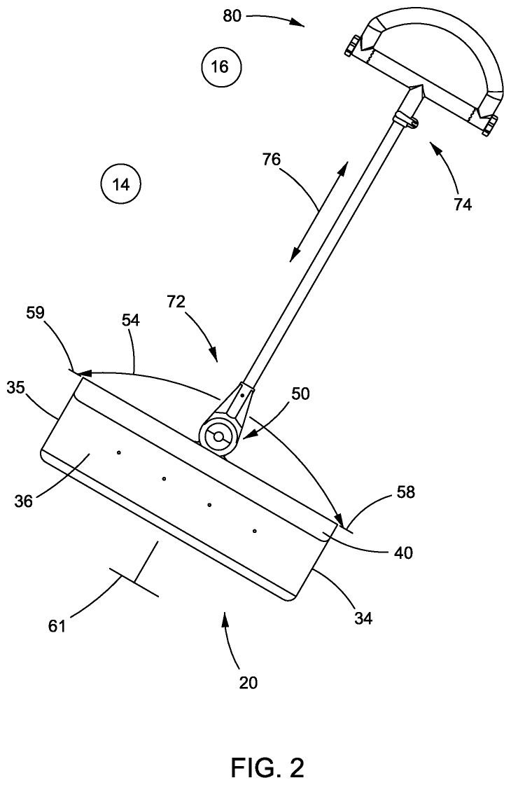

Referring to FIGS. 1, 2, 7 and 8, the T-shaped handle 80 is further described. The T-shaped handle is preferably adjustable angularly 84 relative to or with an elongated axis 78 of the elongated-shaft to select the position 82 of the T-shaped handle relative to the elongated-shaft user end. In this way, for example, the T-shaped handle can be made substantially parallel to the surface for pushing, especially when joint 50 is located out of perpendicular relative to blade 20 (as described further herein). For example, if the T-shaped handle is substantially parallel to the surface, this means comparing the handle's longitudinal axis to a plane defined by the surface and the handle's axis being anywhere from exactly parallel to 18 degrees out of parallel either toward or away from the surface (i.e., there are 90 degrees between parallel and perpendicular and 20% of 90=18 degrees). Additionally, with the T-shaped handle being adjustable angularly, preferably there is an adjustable ring 86 on the handle with a locking clasp 88 to open and close the ring and thereby lock the ring in place around the user end 74 of the shaft 70. Such ring and clasp relationship also includes other similar resulting mechanical structures that can be used as one of ordinary skill in the art would know to do in combination with the teaching herein, to thereby temporarily and selectively lock the T-shaped handle 80 in place relative to the user-end 74. And, this can be done to manage one or both of length direction 76 movement of handle 80 relatively to shaft 70 and/or angular movement 84 of handle 80 relatively to shaft 70.

Still referring to FIGS. 1, 2 and 7, 8, additional features of handle 80 can be understood. For example, the T-shaped handle 80 can include a handle-rung 89. The handle-rung 89 is spaced from the elongated-shaft user end 74 and can be D-shaped as shown, or more U-shaped (not shown) or V-shaped (not shown) or anything in between these, the design being to provide added leverage for easier two-handed control when pushing the shovel 10. Additionally, preferably, handle-rung is adjustable forward-backward (i.e., forward 90 and backward 91, successively) relative to the front face 36 and the back face 40 of the blade 20 to select the position 82 of the handle-rung relative to the elongated-shaft user end 74. Again, the design being to provide added leverage for easier two-handed control when pushing the shovel 10, as well as added versatility for different heights of the handle-rung 89 for different leverage points and/or for different height users. Still additionally, preferably, and if desired, being adjustable forward-backward 90, 91 can be by the structure of interlocking teeth 92 and a screw 94 locking-unlocking relationship, where loosening the screw unlocks the interlocking teeth and tightening the screw locks the interlocking teeth. Yet additionally, preferably, and if desired, the handle-rung 89 can be adjustable forward-backward 90, 91 through a range of motion of at least 90 degrees relative to a shaft length direction 76 of the elongated-shaft 70 (FIG. 6).

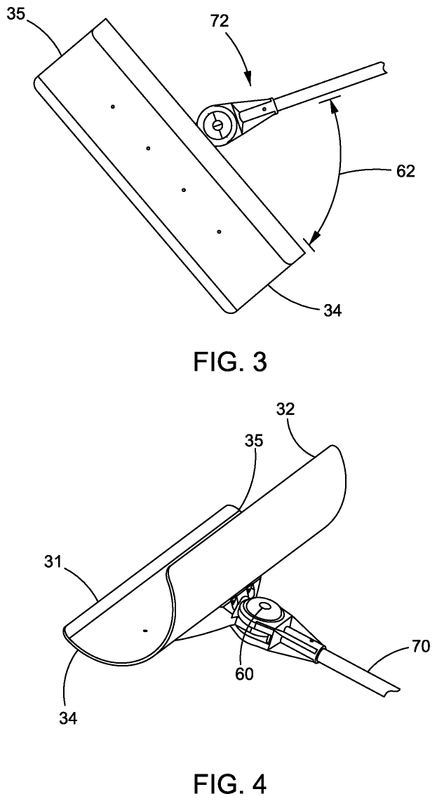

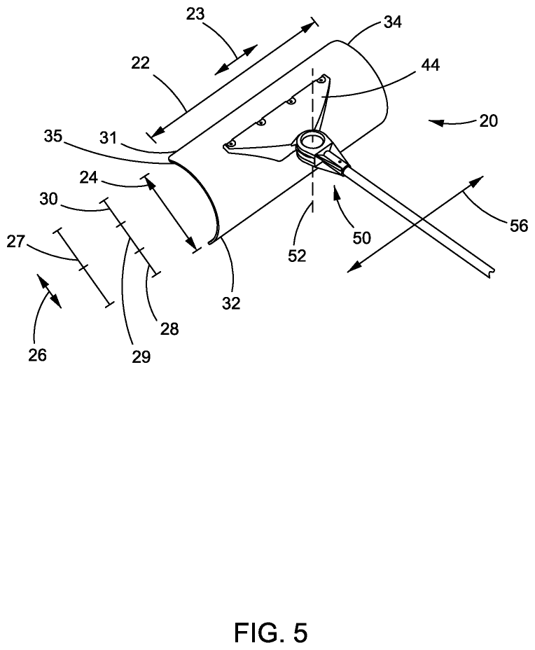

Referring to FIGS. 1-6, additional features of the selectively-pivotable joint 50 are now explained. For example, the selectively-pivotable joint can be located within a bottom half 27 of a distance of the width of the blade with the bottom half 27 including the bottom edge 31 and defined from the top edge 32 to the bottom edge 31. For example, this further aids the leverage provided to the blade from the elongated shaft 70, especially when pushing the blade at an angle in a snowplow-like manner. Additionally, or alternately, and for similar leverage reasons and further aiding in the snow rolling and throwing capability of the concave shaped blade, some portion of the selectively-pivotable joint 50 can be located within a middle one-third 29 of a distance of the width 24 of the blade 20 as defined from the top edge 32 to the bottom edge 31. Additionally, or alternately, and further aiding in the angling of the blade relative to the shaft 70, and thus the blade angle relative to the material on the surface being cleared, the selectively-pivotable joint 50 can be selectively positionable in a direction 56 parallel to a length direction 23 of the blade. Yet additionally, or alternately, and further aiding in the angling of the blade relative to the shaft 70, the selectively-pivotable joint 50 is selectively positionable between zero degrees 58 and 180 degrees 59 relative to the spaced apart side edges 34 of the blade. Further in this regard, and in increasing degrees of preference, the selectively-pivotable joint 50 can be selectively positionable in arc 62 less than ninety degrees such as between ten degrees and forty-five degrees, between ten degrees and thirty degrees, between fifteen degrees and thirty degrees, and between fifteen degrees and twenty-five degrees, on either side of a perpendicular position 61 defined by the elongated-shaft relative to the blade.

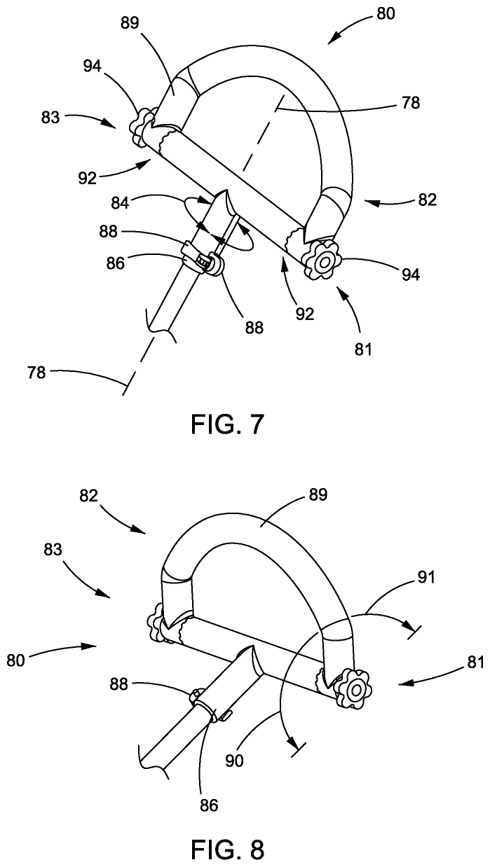

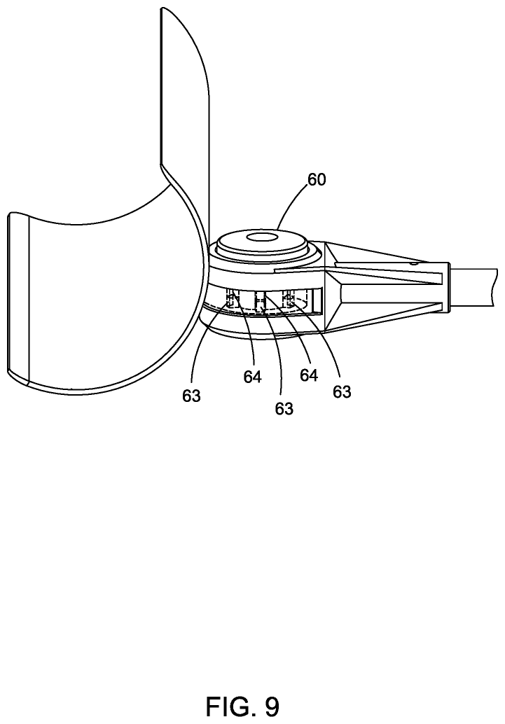

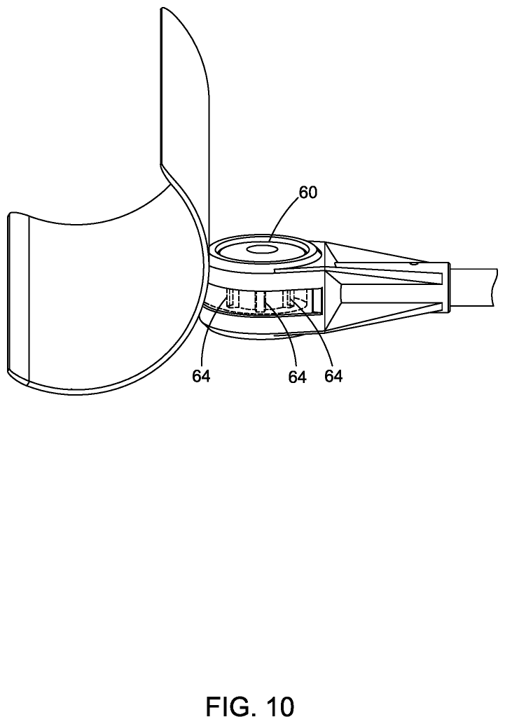

Referring to FIGS. 9 and 10, yet additional features of the joint 50 are explained. For example, the selectively-pivotable joint 50 can be a button 60 operative with a spring (internal to the structure and not seen) where depressing the button 60 unlocks the joint 50 and unpressing the button 60 locks the joint. FIG. 10 shows the unlocked orientation with the button depressed, and consequently the teeth 63 pressed out of locking slots 64, and then the joint can be freely pivoted so the blade 20 and elongated-shaft 70 can move to a desired position relative to one another, and then be locked in place as desired once the button is no longer depressed. In FIG. 9, the joint is in a locked orientation so teeth 63 are locked into slots 64 and the joint no longer freely pivots so the blade 20 and elongated-shaft 70 cannot move out of the desired position. A relationship like that detailed in FIGS. 7-8 for interlocking teeth 92 and screw 94 could alternately be employed here too, but would be less preferred here because not as easily and readily selectively adjustable as the discussed spring, teeth 63 and locking slots 64.

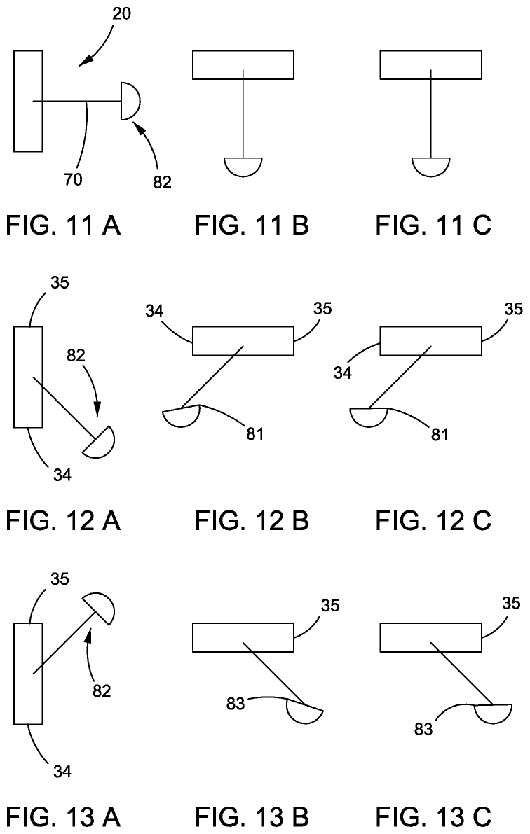

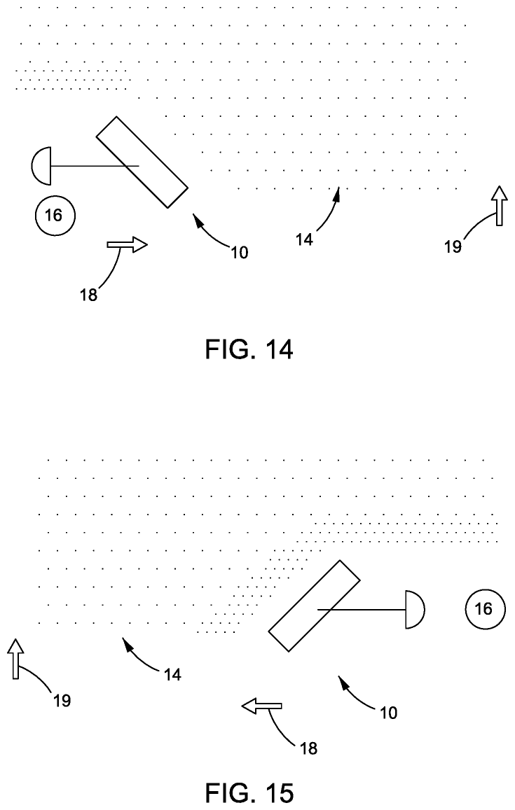

To use my innovative shovel 10, generally as seen in the FIGs. and especially FIGS. 11-15 inclusive, there is disclosed a method for pushing the shovel to clear material 14 from the surface 16. The method includes a first step of using blade 20, with blade 20 having one or more of the features described above. Another step is selectively-pivoting joint 50 connected with the elongated-shaft blade end 72 and the back face 40 of the blade 20. Further in this step, the joint 50 is fixed in place relative to the length direction 23 of the blade and pivots around joint center point 52 to move the elongated-shaft 70, and most pronouncedly user end 74, in arc 54 relative to spaced apart side edges 34 of the blade 20. A further step is angularly adjusting T-shaped handle 80 connected with the elongated-shaft user end 74 to position the T-shaped handle 80 substantially parallel to the surface 16 when the elongated-shaft user end 74 is positioned from ten degrees to forty-five degrees on either side of perpendicular position 61 defined by the elongated-shaft 70 relative to the blade 20. And, a still further step is then pushing, e.g., in direction of force 18 and first as seen in FIG. 14, the shovel 10 with the blade and joint so configured to thereby push material aside in a material clearing direction 19, e.g., in a snowplow-like manner.

For similar reasons discussed above, and further seen in use of shovel 10 and depicted in FIGS. 11-13 inclusive, the leverage provided to the blade 20 from the elongated shaft 70, especially when pushing the blade at an angle in a snowplow-like manner, can be preferably employed with a step of pivoting the joint by moving the elongated-shaft user end 74 toward the left spaced apart side edge 34 of the blade (e.g., FIGS. 12A to 12B) and angularly adjusting the T-shaped handle 80 by moving a far left edge of the T-shaped handle upward relative to the surface 16 (e.g., FIGS. 12B to 12C). As depicted, FIG. 12A shows a top view of the pivoting of shaft 70 toward left edge 34. FIG. 12B shows a back view of the way handle 80 will be oriented if not angularly-adjusted from its level-with-the-surface orientation when the shaft and the joint 50 is in the perpendicular orientation 61. Then, FIG. 12C shows a back view of the way handle 80 will be oriented if the T-shaped handle is angularly-adjusted by moving a far left edge 81 of the T-shaped handle upward relative to the surface 16 and thereby make the T-shaped handle be substantially level with the surface 16, especially when the shaft and the joint 50 are in an arc position 62 that is less not the perpendicular orientation 61. Further in this regard, additionally or alternately, there can be a step of pivoting the joint 50 by moving the elongated-shaft user end 74 toward a right spaced apart side edge 35 of the blade (e.g., FIGS. 13A to 13B) and angularly adjusting the T-shaped handle 80 by moving a far right edge 83 of the T-shaped handle upward relative to the surface 16 (e.g., FIGS. 13B to 13C). Yet additionally or alternately, in this regard, there can be a step of substantially leveling (e.g., FIGS. 12B to 12C, and alternately 13B to 13C, respectviely) the T-shaped handle 80 relative to the surface 16 when pivoting the joint 50 by moving the elongated-shaft user end 74 toward the left spaced apart side edge 34 (e.g., FIGS. 12A to 12B) of the blade or toward the right spaced apart side edge 35 (e.g., FIGS. 13A to 13B) of the blade. And yet additionally, now also referring to

FIGS. 14 and 15, preferably in between each of the pivoting steps described in this paragraph, there can be a step of pushing the shovel (e.g., with and in direction of force 18) in an opposite direction (FIG. 15) to clear material 14 from the surface, and with the blade in an opposite orientation (FIG. 15) from when the blade was pushed in the first direction of travel (FIG. 14), to thereby continue to push material 14 further aside in a same material clearing direction 19, e.g., in a snowplow-like manner until the material is cleared, as much as desired, off of the surface 16. And, for completeness, FIG. 11A shows a top view of the perpendicular position 61 of shaft 70 when not in a snowplow-like orientation, and thus FIG. 11B shows a back view of the way handle 80 will be oriented substantially level with the surface and not need any angular-adjusting when simply pushing the shovel in the perpendicular position 61, and therefore, FIG. 11C shows the same back view of the handle 80 as for FIG. 11B because the T-shaped handle is already substantially level with the surface.

Referring to FIGS. 1, 2, 7 and 8, additional features of the shaft relative to the blade and the handle are now explained. For example, this further aids the leverage provided to the blade from the elongated shaft 70, especially when pushing the blade at an angle in a snowplow-like manner. The method can include some portion of the joint 50 being located within the middle one-third 29 of the distance of the width 24 of the blade as defined from the top edge 28 to the bottom edge 30. Additionally, preferably, there can be a step with the T-shaped handle 80 including handle-rung 89, and then and further comprising adjusting the handle-rung 89 forward-backward 90, 91 relative to the front face 36 and the back face 40 of the blade to selectively position the T-shaped handle-rung 89 relative to the elongated-shaft user end 74.

Additional discussion of the disclosure in various embodiments now follows:
A. A manually operated shovel designed to be pushed by a user to clear material from a surface. The shovel includes a blade. The blade includes a length and a width, where the length is greater than the width. The blade also includes a bottom edge to engage the surface and a top edge spaced from the bottom edge. The blade further includes a front face defined between the top edge and the bottom edge. And, the blade includes a back face defined between the top edge and the bottom edge wherein the back face is opposed to and separated from the front face. The shovel further includes an elongated-shaft having an elongated-shaft blade end and an elongate-shaft user end, where the elongated-shaft user end is spaced apart from the elongated-shaft blade end. Further, the shovel includes a selectively-pivotable joint connected with an elongated-shaft blade end and the back face of the blade. The selectively-pivotable joint (i) is fixed in place relative to the length direction of the blade and (ii) pivots around a joint center point to move an elongated-shaft user end in an arc relative to spaced apart side edges of the blade. Yet further, the shovel includes a T-shaped handle connected with the elongated-shaft user end. The T-shaped handle is selectively-adjustable to enable the user to adjust a position of the T-shaped handle relative to the elongated-shaft user end.
B. The shovel of any of the prior embodiments, wherein the front face is concave shaped.
C. The shovel of any of the prior embodiments, wherein the back face is convex shaped.
D. The shovel of any of the prior embodiments, wherein the selectively-pivotable joint is located within a bottom half of a distance of the width of the blade with the bottom half including the bottom edge and defined from the top edge to the bottom edge.
E. The shovel of any of the prior embodiments, wherein some portion of the selectively-pivotable joint is located within a middle one-third of a distance of the width of the blade as defined from the top edge to the bottom edge.
F. The shovel of any of the prior embodiments, wherein the selectively-pivotable joint is selectively positionable in a direction parallel to a length direction of the blade.
G. The shovel of any of the prior embodiments, wherein the selectively-pivotable joint is selectively positionable between zero degrees and 180 degrees relative to the spaced apart side edges of the blade.
H. The shovel of any of the prior embodiments, wherein the selectively-pivotable joint is selectively positionable between ten degrees and forty-five degrees on either side of a perpendicular position defined by the elongated-shaft relative to the blade.
I. The shovel of any of the prior embodiments, wherein the selectively-pivotable joint is selectively positionable between fifteen degrees and thirty degrees on either side of a perpendicular position defined by the elongated-shaft relative to the blade.
J. The shovel of any of the prior embodiments, wherein the selectively-pivotable joint comprises a button operative with a spring wherein depressing the button unlocks the joint and unpressing the button locks the joint.
K. The shovel of any of the prior embodiments, wherein the elongated-shaft has a shaft length direction that is parallel with at least a portion of the blade in a width direction of the blade.
L. The shovel of any of the prior embodiments, wherein the T-shaped handle is adjustable angularly with an elongated axis of the elongated-shaft to select the position of the T-shaped handle relative to the elongated-shaft user end.
M. The shovel of any of the prior embodiments, wherein adjustable angularly comprises a selectively adjustable ring and locking clasp relationship between the T-shaped handle and the elongated-shaft.
N. The shovel of any of the prior embodiments, wherein the T-shaped handle includes a handle-rung, and the handle-rung is spaced from elongated-shaft user end and is adjustable forward-backward relative to the front face and the back face of the blade to select the position of the handle-rung relative to the elongated-shaft user end.
O. The shovel of any of the prior embodiments, wherein adjustable forward-backward comprises interlocking teeth and a screw wherein loosening the screw unlocks the interlocking teeth and tightening the screw locks the interlocking teeth.
P. The shovel of any of the prior embodiments, wherein the handle-rung is adjustable forward-backward through a range of motion of at least 90 degrees relative to a shaft length direction of the elongated-shaft.
Q. A method for pushing a shovel to clear material from a surface. The method includes using a blade as described herein. The method also includes selectively-pivoting a joint connected with an elongated-shaft blade end and the back face of the blade, where the joint (i) is fixed in place relative to the length direction of the blade and (ii) pivots around a joint center point to move an elongated-shaft user end in an arc relative to spaced apart side edges of the blade. Another step of the method is angularly adjusting a T-shaped handle connected with the elongated-shaft user end to position the T-shaped handle substantially parallel to the surface when the elongated-shaft user end is positioned from ten degrees to forty-five degrees on either side of a perpendicular position defined by the elongated-shaft relative to the blade. Then, this is a step of pushing the shovel to clear material from the surface.
R. The method of any of the prior method embodiments, further comprising pivoting the joint by moving the elongated-shaft user end toward a left spaced apart side edge of the blade and angularly adjusting the T-shaped handle by moving a far left edge of the T-shaped handle upward relative to the surface.
S. The method of any of the prior method embodiments, further comprising pivoting the joint by moving the elongated-shaft user end toward a right spaced apart side edge of the blade and angularly adjusting the T-shaped handle by moving a far right edge of the T-shaped handle upward relative to the surface.
T. The method of any of the prior method embodiments, further comprising pushing the shovel in an opposite direction to clear material from the surface and with the blade in an opposite orientation to thereby continue to push material further aside in a same material clearing direction.
U. The method of any of the prior method embodiments, further comprising substantially leveling the T-shaped handle relative to the surface when pivoting the joint by moving the elongated-shaft user end toward the left spaced apart side edge of the blade or toward the right spaced apart side edge of the blade.
V. The method of any of the prior method embodiments, wherein some portion of the joint is located within a middle one-third of a distance of the width of the blade as defined from the top edge to the bottom edge.
W. The method of any of the prior method embodiments, wherein the T-shaped handle includes a handle-rung and further comprising adjusting the handle-rung forward-backward relative to the front face and the back face of the blade to selectively position the T-shaped handle-rung relative to the elongated-shaft user end.

Each and every document cited in this present application, including any cross referenced or related patent or application, is incorporated in this present application in its entirety by this reference, unless expressly excluded or otherwise limited. The citation of any document is not an admission that it is prior art with respect to any embodiment disclosed in this present application or that it alone, or in any combination with any other reference or references, teaches, suggests, or discloses any such embodiment. Further, to the extent that any meaning or definition of a term in this present application conflicts with any meaning or definition of the same term in a document incorporated by reference, the meaning or definition assigned to that term in this present application governs.

The invention includes the description, examples, features, embodiments, and drawings disclosed; but it is not limited to such description, examples, features, embodiments, or drawings. As briefly described above, the reader should assume that features of one disclosed embodiment can also be applied to all other disclosed embodiments, unless expressly indicated to the contrary. Unless expressly indicated to the contrary, the numerical parameters set forth in the present application are approximations that can vary depending on the desired properties sought to be obtained by a person of ordinary skill in the art without undue experimentation using the teachings disclosed in the present application. Modifications and other embodiments will be apparent to a person of ordinary skill in the shovel art in combination with the teachings disclosed here, and all such modifications and other embodiments are intended and deemed to be within the scope of the invention.

What is claimed is:

1. A manually operated shovel designed to be pushed by a user to clear material from a surface, comprising:
a blade comprising:
a length and a width wherein the length is greater than the width,
a bottom edge to engage the surface and a top edge spaced from the bottom edge,
a front face defined between the top edge and the bottom edge, and
a back face defined between the top edge and the bottom edge wherein the back face is opposed to and separated from the front face;
an elongated-shaft having an elongated-shaft blade end and an elongate-shaft user end wherein the elongated-shaft user end is spaced apart from the elongated-shaft blade end;
a selectively-pivotable joint connected with an elongated-shaft blade end and the back face of the blade wherein the selectively-pivotable joint (i) is fixed in place relative to a length direction of the blade and (ii) pivots around a joint center point to move an elongated-shaft user end in an arc relative to spaced apart side edges of the blade; and,
a T-shaped handle connected with the elongated-shaft user end wherein the T-shaped handle is selectively-adjustable to enable the user to adjust a position of the T-shaped handle relative to the elongated-shaft user end.

2. The shovel of claim 1, wherein the front face is concave shaped.

3. The shovel of claim 2, wherein the back face is convex shaped.

4. The shovel of claim 1, wherein the selectively-pivotable joint is located within a bottom half of a distance of the width of the blade with the bottom half including the bottom edge and defined from the top edge to the bottom edge.

5. The shovel of claim 1, wherein some portion of the selectively-pivotable joint is located within a middle one-third of a distance of the width of the blade as defined from the top edge to the bottom edge.

6. The shovel of claim 1, wherein the selectively-pivotable joint is selectively positionable in a direction parallel to a length direction of the blade.

7. The shovel of claim 1, wherein the selectively-pivotable joint is selectively positionable between zero degrees and 180 degrees relative to the spaced apart side edges of the blade.

8. The shovel of claim 7, wherein the selectively-pivotable joint is selectively positionable between ten degrees and forty-five degrees on either side of a perpendicular position defined by the elongated-shaft relative to the blade.

9. The shovel of claim 8, wherein the selectively-pivotable joint is selectively positionable between fifteen degrees and thirty degrees on either side of a perpendicular position defined by the elongated-shaft relative to the blade.

10. The shovel of claim 1, wherein the selectively-pivotable joint comprises a button operative with a spring wherein depressing the button unlocks the selectively-pivotable joint and unpressing the button locks the selectively-pivotable joint.

11. The shovel of claim 1, wherein the elongated-shaft has a shaft length direction that is parallel with at least a portion of the blade in a width direction of the blade.

12. The shovel of claim 1, wherein the T-shaped handle is adjustable angularly with an elongated axis of the elongated-shaft to select the position of the T-shaped handle relative to the elongated-shaft user end.

13. The shovel of claim 12, wherein adjustable angularly comprises a selectively adjustable ring and locking clasp relationship between the T-shaped handle and the elongated-shaft.

14. The shovel of claim 1, wherein the T-shaped handle includes a handle-rung, and the handle-rung is spaced from elongated-shaft user end and is adjustable forward-backward relative to the front face and the back face of the blade to select the position of the handle-rung relative to the elongated-shaft user end.

15. The shovel of claim 14, wherein adjustable forward-backward comprises interlocking teeth and a screw wherein loosening the screw unlocks the interlocking teeth and tightening the screw locks the interlocking teeth.

16. The shovel of claim 14, wherein the handle-rung is adjustable forward-backward through a range of motion of at least 90 degrees relative to a shaft length direction of the elongated-shaft.

17. A method for pushing a shovel to clear material from a surface, comprising:
using a blade comprising: a length and a width wherein the length is greater than the width, a bottom edge to engage the surface and a top edge spaced from the bottom edge, a front face defined between the top edge and the bottom edge, and a back face defined between the top edge and the bottom edge wherein the back face is opposed to and separated from the front face;
selectively-pivoting a joint connected with of an elongated-shaft at an elongated-shaft blade end joined with the back face of the blade wherein the joint (i) is fixed in place relative to a length direction of the blade and (ii) pivots around a joint center point to move an elongated-shaft user end in an arc relative to spaced apart side edges of the blade;
angularly adjusting T-shaped handle connected with the elongated-shaft user end to position the T-shaped handle substantially parallel to the surface when the elongated-shaft user end is positioned from ten degrees to forty-five degrees on either side of a perpendicular position defined by the elongated-shaft relative to the blade; and,
pushing the shovel to clear material from the surface.

18. The method of claim 17, further comprising pivoting the joint by moving the elongated-shaft user end toward a left spaced apart side edge of the blade and angularly adjusting the T-shaped handle by moving a far left edge of the T-shaped handle upward relative to the surface.

19. The method of claim 18, further comprising pivoting the joint by moving the elongated-shaft user end toward a right spaced apart side edge of the blade and angularly adjusting the T-shaped handle by moving a far right edge of the T-shaped handle upward relative to the surface.

20. The method of claim 19, further comprising pushing the shovel in an opposite direction to clear material from the surface and with the blade in an opposite orientation to thereby continue to push material further aside in a same material clearing direction.

21. The method of claim 17, further comprising substantially leveling the T-shaped handle relative to the surface when pivoting the joint by moving the elongated-shaft user end toward a left spaced apart side edge of the blade or toward a right spaced apart side edge of the blade.

22. The method of claim 17, wherein some portion of the joint is located within a middle one-third of a distance of the width of the blade as defined from the top edge to the bottom edge.

23. The method of claim 17, wherein the T-shaped handle includes a handle-rung and further comprising adjusting the handle-rung forward-backward relative to the front face and the back face of the blade to selectively position the T-shaped handle relative to the elongated-shaft user end.
